(19) United States
(12) Patent Application Publication
(10) Pub. No.: US 2017/0032085 A1
(43) Pub. Date: Feb. 2, 2017

(54) METHODS FOR FACILITATING MEDICAL SERVICES BY MOBILE HEALTH PROFESSIONALS AND DEVICES THEREOF

(71) Applicant: IGGBO, INC., Henrico, VA (US)

(72) Inventors: Mark VAN ROEKEL, Richmond, VA (US); Nuno VALENTINE, Richmond, VA (US)

(21) Appl. No.: 15/294,237

(22) Filed: Oct. 14, 2016

Related U.S. Application Data
(63) Continuation of application No. PCT/US2015/065580, filed on Dec. 14, 2015.
(60) Provisional application No. 62/091,030, filed on Dec. 12, 2014.

(51) Int. Cl. G06F 19/00; G06Q 10/10

(52) U.S. Cl. CPC G06F 19/327; G06Q 10/1095; G06F 19/328

(57) ABSTRACT

Methods, non-transitory computer readable media, and medical service management computing devices that obtain an order for a medical service and appointment schedule data for mobile health professionals comprising at least an appointment location and a time of appointments scheduled prior and subsequent to an order time. Ingress and egress travel times for the mobile health professionals are determined based on an order location and the appointment locations. Mobile health professional(s) capable of providing the medical service at the order location and the order time are identified based on the ingress and egress travel times and the appointment time of the prior and subsequent appointments. An invitation is sent to mobile health professional computing devices associated with one or more of the mobile health professional(s). An acceptance of the invitation is received from one of the mobile health professional computing devices. The appointment schedule data is updated to reflect the order.

This application is a continuation of PCT/US2015/065580, filed Dec. 14, 2015, which claims the benefit of U.S. Provisional Patent Application Ser. No. 62/091,030, filed on Dec. 12, 2014, which are hereby incorporated by reference in their entirety.

### FIELD

This technology relates to patient medical services performed by mobile health professionals, and more specifically, to methods and devices for facilitating efficient delivery of medical services to improve compliance and associated patient outcomes.

### BACKGROUND

Current delivery models for medical services are inefficient and ineffective, resulting in reduced patient compliance. As one example, regulatory measures currently prohibit payment directly to physician offices for venipuncture procedures by clinical staff, which has resulted in fewer physicians offering on-site phlebotomy services. With fewer points of presence and convenience, more patients miss appointments at clinical laboratories or otherwise fail to complete physician recommended blood draws, and patient compliance has therefore been decreasing. Since clinical laboratories provide testing that influences a significant percentage of medical decision making, reduced patient compliance is increasingly having a significant and negative impact on patient health, treatments, and outcomes.

### SUMMARY

A method for facilitating medical services by mobile health professionals includes obtaining, by a medical service management computing device, an order for a medical service and appointment schedule data for a plurality of mobile health professionals comprising at least an appointment location and an appointment time of appointments scheduled prior and subsequent to an order time in the order. Ingress and egress travel times for each of the mobile health professionals are determined, by the medical service management computing device, based on an order location in the order and the appointment locations of the prior and subsequent appointments. One or more of the mobile health professionals capable of providing the medical service at the order location and the order time are identified from a health professional database, by the medical service management computing device, based on the ingress and egress travel times and the appointment times of the prior and subsequent appointments. An invitation is sent, by the medical service management computing device, to one or more mobile health professional computing devices associated with one or more of the mobile health professionals. An acceptance of the invitation is received, by the medical service management computing device, from one of the mobile health professional computing devices. The appointment schedule data for one of the mobile health professionals associated with the one of the mobile health professional computing devices is updated, by the medical service management computing device, for the order.

A medical service management computing device includes a processor and a memory coupled to the processor which is configured to be capable of executing programmed instructions including and stored in the memory to obtain an order for a medical service and appointment schedule data for a plurality of mobile health professionals comprising at least an appointment location and an appointment time of appointments scheduled prior and subsequent to an order time in the order. Ingress and egress travel times for each of the mobile health professionals are determined based on an order location in the order and the appointment locations of the prior and subsequent appointments. One or more of the mobile health professionals capable of providing the medical service at the order location and the order time are identified from a health professional database based on the ingress and egress travel times and the appointment times of the prior and subsequent appointments. An invitation is sent to one or more mobile health professional computing devices associated with one or more of the mobile health professionals. An acceptance of the invitation is received from one of the mobile health professional computing devices. The appointment schedule data for one of the mobile health professionals associated with the one of the mobile health professional computing devices is updated for the order.

A non-transitory computer readable medium having stored thereon instructions for facilitating medical services by mobile health professionals comprising executable code which when executed by a processor, causes the processor to perform steps including obtaining an order for a medical service and appointment schedule data for a plurality of mobile health professionals comprising at least an appointment location and an appointment time of appointments scheduled prior and subsequent to an order time in the order. Ingress and egress travel times for each of the mobile health professionals are determined based on an order location in the order and the appointment locations of the prior and subsequent appointments. One or more of the mobile health professionals capable of providing the medical service at the order location and the order time are identified from a health professional database based on the ingress and egress travel times and the appointment times of the prior and subsequent appointments. An invitation is sent to one or more mobile health professional computing devices associated with one or more of the mobile health professionals. An acceptance of the invitation is received from one of the mobile health professional computing devices. The appointment schedule data for one of the mobile health professionals associated with the one of the mobile health professional computing devices is updated for the order.

This technology has a number of associated advantages including providing methods, non-transitory computer readable media, and medical service management computing devices that more effectively and efficiently facilitate medical services by mobile health professionals and address issues with prior electronic scheduling systems. With this technology, mobile health professionals are automatically identified based on availability, capability, proximity, and/or quality and selected by a patient or a medical care provider to perform a medical service for the patient at a specified time and place that is convenient for the patient, thereby improving patient compliance.

Additionally, this technology more effectively schedules and monitors just-in-time-and-place services provided by mobile health professionals, thereby addressing deficiencies in current electronic scheduling systems that merely schedule services for a geographically closest proximate service provider irrespective of prior and subsequent appointments, and are not capable of reassignment upon an automated determination that a service provider is unlikely to make an appointment. This technology also advantageously facilitates connections between medical health professionals and clinical laboratories, and manages invoicing and payment processing for the laboratories and the mobile medical health professionals.

### BRIEF DESCRIPTION OF THE DRAWINGS

FIG. 1 a block diagram of a network environment with an exemplary medical service management computing device;

FIG. 2 is a block diagram of the exemplary medical service management computing device shown in FIG. 1;

FIG. 3 is a flowchart of an exemplary method for facilitating medical services by mobile health professionals with the exemplary medical service management computing device;

FIG. 4 is a block diagram illustrating registration aspects of the exemplary method for facilitating medical services by mobile health professionals shown in FIG. 3;

FIG. 5 is an exemplary medical service order interface for use by a medical care provider;

FIGS. 6A, 6B, and 6C are exemplary medical service order interfaces for use by a patient;

FIG. 7 is an exemplary mobile health professional selection interface;

FIGS. 8A and 8B are exemplary mobile health professional interfaces for viewing appointment information and receiving new invitations;

FIG. 9 is a block diagram illustrating medical service ordering and scheduling aspects of the exemplary method for facilitating medical services by mobile health professionals shown in FIG. 3;

FIG. 10 is a block diagram illustrating compliance and monitoring aspects of the exemplary method for facilitating medical services by mobile health professionals shown in FIG. 3; and

FIG. 11 is a block diagram illustrating medical service processing aspects of the exemplary method for facilitating medical services by mobile health professionals shown in FIG. 3.

### DETAILED DESCRIPTION

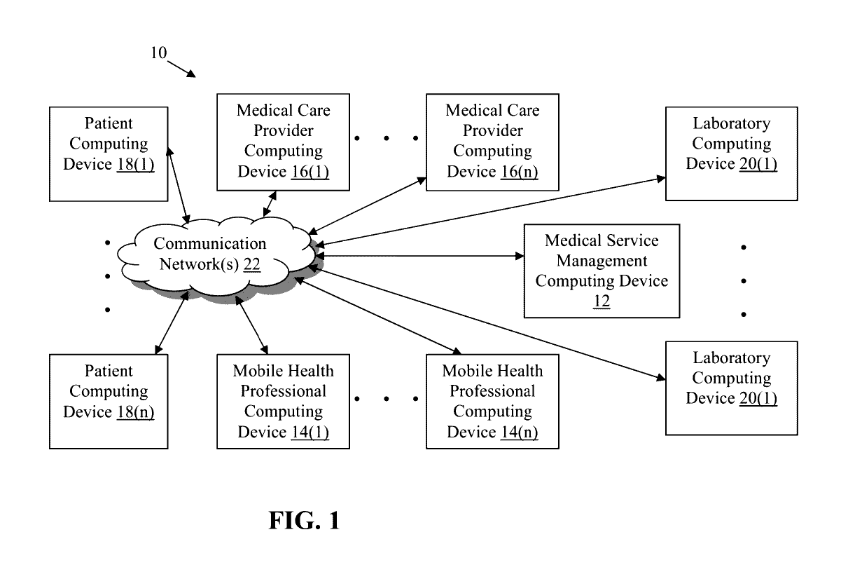

Referring to FIG. 1, a block diagram is shown including an exemplary network environment 10 which incorporates a medical service management computing device 12 coupled to mobile health professional computing devices 14(1)-14(n), medical care provider computing devices 16(1)-16(n), patient computing devices 18(1)-18(n), and laboratory computing devices 20(1)-20(n) a via communication network(s) 22, although one or more of these devices can be coupled together via other topologies. Additionally, the network environment 10 may include other network devices such as one or more routers and/or switches, by way of example only, which are known to those skilled in the art and will not be described here.

This technology provides a number of advantages including methods, non-transitory computer readable media, and medical service management computing devices that more effectively and efficiently schedule and facilitate remote medical services performed on patients by mobile health professionals in order to improve patient compliance and outcomes. This technology is described and illustrated herein with reference to venipuncture or blood draw medical services performed by phlebotomists, which are each associated with one of the mobile health professional computing devices 14(1)-14(n), by way of example only. However, in other examples, this technology can be used for other types of medical services and by other types of medical health professionals.

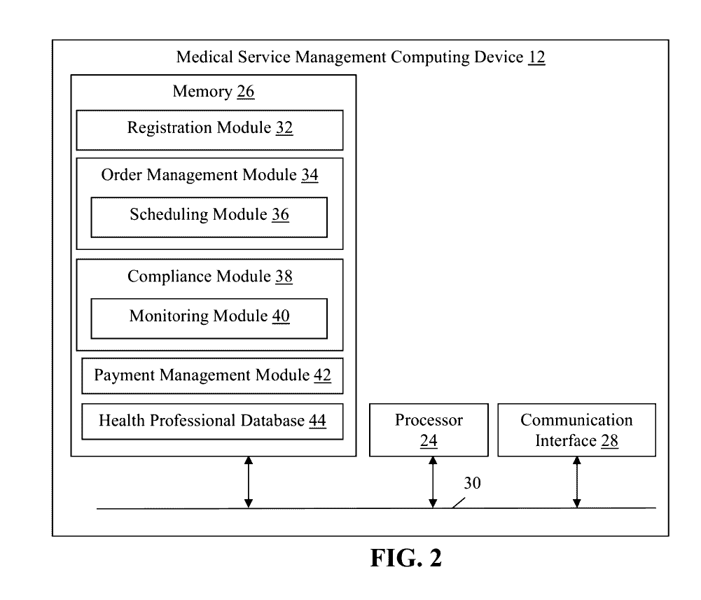

Referring to FIGS. 1-2, the medical service management computing device 12 includes a processor 24, a memory 26, and a communication interface 28, which are coupled together by a bus 30 or other communication link, although the medical service management computing device 12 may include other types and/or numbers of elements in other configurations. The processor 24 of the medical service management computing device 12 may execute programmed instructions stored in the memory 26 of the medical service management computing device 12 for the any of the functions described and illustrated herein. The processor 24 of the medical service management computing device 12 may include one or more CPUs or general purpose processors with one or more processing cores, by way of example only.

The memory 26 of the medical service management computing device 12 stores these programmed instructions for one or more aspects of the present technology, as described and illustrated herein, although some or all of the programmed instructions could be stored or executed elsewhere. A variety of different types of memory storage devices, such as random access memory (RAM), read only memory (ROM), flash, hard disks, solid state drives, or other computer readable media which is read from and written to by a magnetic, optical, or other reading and writing system that is coupled to the processor 24, can be used for the memory 26.

In this particular example, the memory 26 of the medical service management computing device 12 includes a registration module 32, an order management module 34 including a scheduling module 36, a compliance module 38 including a monitoring module 40, a payment management module 42, and a health professional database although other types and numbers of modules can be used in other examples. In this example, the registration module 32 facilitates registration by mobile health professionals, laboratories, medical care providers, and optionally patients, as described and illustrated in more detail later.

The order management module 34 of the medical service management computing device 12 in this example facilitates receipt of medical service orders from the medical care provider computing devices 16(1)-16(n) or the patient computing devices 18(1)-18(n). Accordingly, a physician or patient can interface with the order management module 34 to order a blood draw, for example. The scheduling module 36 of the order management module 34 then uses the details of the medical service order to identify mobile health professionals available to and capable of performing the medical service using appointment schedule data stored in the memory 26 and other information, as described and illustrated in more detail later.

The compliance module 38 of the medical service management computing device 12 maintains communication with patient and mobile health professionals in order to ensure that the appointment proceeds successfully. The monitoring module 40 of the compliance module 38 in this example performs a number of functions to determine whether an appointment requires reassignment to another mobile health professional, also as described and illustrated in more detail later.

In one example, the monitoring module 40 monitors a geographic location of each of the mobile health professional computing devices 14(1)-14(n) and, using the appointment schedule data, determines whether the associated mobile health professionals will be able to make a subsequent appointment. Accordingly, the monitoring module 40 can use the geographic location and the appointment schedule data to determine based on an appointment time of a subsequent appointment, the current time, and a determined travel time required to get to the subsequent appointment, whether there is a relatively high risk a mobile health professional will not make the subsequent appointment. The compliance module 38 and/or monitoring module 40 can also perform other functions in other examples, as described and illustrated in more detail later.

The payment management module 42 of the medical service management computing device 12 facilitates invoicing of the laboratory to which the drawn blood was sent by the mobile health profession, which is a phlebotomist in this example. The payment management module 42 also distributes portions of payments received from the laboratory computing devices 20(1) to the mobile health professionals in order to compensate the mobile health professionals for performing the medical service. The payment management module 42 can also perform other numbers and types of functions in other examples.

The health professional database 44 in this example stores data regarding mobile health professionals that are available to perform medical services. The data can include registration data including contact data, demographic data, qualification data, experience data, and payment processing and bank account data that facilitates electronic payment for providing the medical services. Other data and information regarding the mobile health professionals can also be stored in the health professional database 44.

The communication interface 28 of the medical service management computing device 12 operatively couples and communicates between the medical service management computing device 12 and the mobile health professional computing devices 14(1)-14(n), medical care provider computing devices 16(1)-16(n), patient computing devices 18(1)-18(n), and laboratory computing devices 20(1)-20(n), which are all coupled together by the communication network(s) 22, although other types and/or numbers of communication networks or systems with other types and/or numbers of connections and configurations to other devices and elements can also be used.

By way of example only, the communication network(s) 22 can use TCP/IP over Ethernet and industry-standard protocols, although other types and/or numbers of communication networks can be used. The communication network(s) 22 in this example may employ any suitable interface mechanisms and network communication technologies including, by way of example only, teletraffic in any suitable form (e.g., voice, modem, and the like), Public Switched Telephone Network (PSTNs), Ethernet-based Packet Data Networks (PDNs), combinations thereof, and the like.

Each of the mobile health professional computing devices 14(1)-14(n), medical care provider computing devices 16(1)-16(n), patient computing devices 18(1)-18(n), and laboratory computing devices 20(1)-20(n) in this example includes a processor, a memory, and a communication interface, which are coupled together by a bus or other communication link, although other types and/or numbers of network devices could also be used. The mobile health professional computing devices 14(1)-14(n) may run interface applications, such as Web browsers by way of example only, which may provide an interface to the medical service management computing device 12 for mobile health professionals, such as phlebotomists, to receive and accept invitations, confirm appointments, provide geographic location for monitoring purposes, and process information during a medical service, such as a blood draw, for example.

The medical care provider mobile computing devices 16(1)-16(n) and the patient computing devices 18(1)-18(n) may run interface applications, such as Web browsers by way of example only, which may provide an interface to submit medical service orders to the medical service management computing device 12, for example, among other functions. Additionally, the laboratory computing devices 20(1)-20(n) may run interface applications, such as Web browsers by way of example only, which provide an interface to track associated mobile health professionals, such as phlebotomists, appointments, and packages, for example, using the medical service management computing device 12, as well as process payments to the medical service management computing device 12. The mobile health professional computing devices 14(1)-14(n), medical care provider computing devices 16(1)-16(n), patient computing devices 18(1)-18(n), and laboratory computing devices 20(1)-20(n) may further include a display device, such as a display screen or touchscreen, and/or an input device, such as a keyboard by way of example only.

Although the exemplary network environment 10 with the medical service management computing device 12, mobile health professional computing devices 14(1)-14(n), medical care provider computing devices 16(1)-16(n), patient computing devices 18(1)-18(n), laboratory computing devices 20(1)-20(n), and communication network(s) 22 are described and illustrated herein, other types and/or numbers of systems, devices, components, and elements in other topologies can be used. The systems of the examples described herein are for exemplary purposes, as many variations of the specific hardware and software used to implement the examples are possible, as will be appreciated by those skilled in the relevant art(s).

Additionally, this technology may be embodied as one or more non-transitory computer readable media having instructions stored thereon for one or more aspects of the technology as described and illustrated by way of the examples herein, which when executed by a processor, cause the processor to carry out the steps necessary to implement the methods of the technology, as described and illustrated herein.

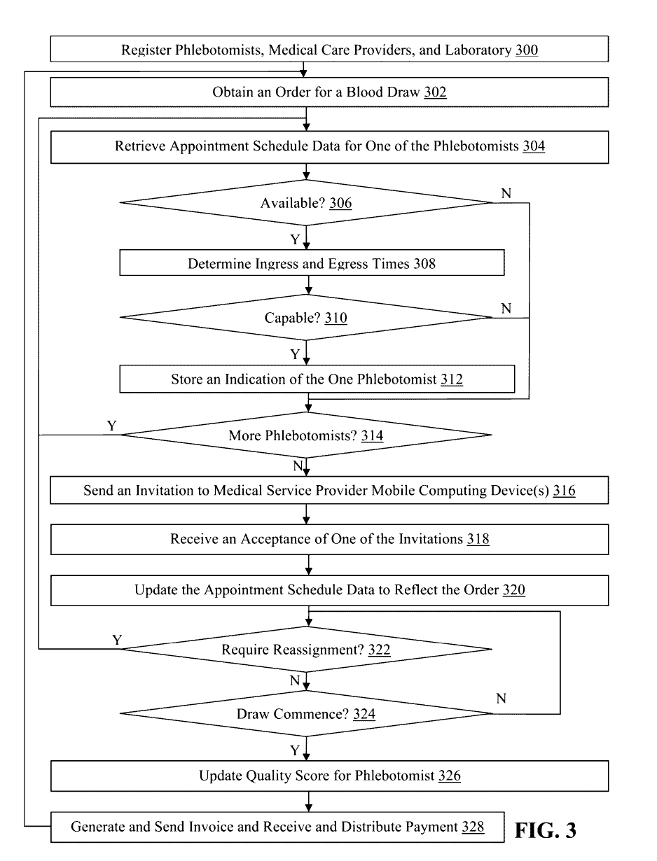

Referring to FIG. 3, an exemplary method for facilitating medical services by mobile health professionals will now be described. In step 300 in this example, the registration module 32 executing on the medical management computing devices 12 obtains registration data in order to register phlebotomists, medical care providers (e.g., physicians), and clinical laboratories. In one example, phlebotomist registration data can be obtained via web page interface(s) provided to the mobile health professional computing devices 14(1)-14(n). The phlebotomist registration data can include contact and login information and questionnaire data relating to certifications, licenses, course completion, equipment, and/or experience, for example.

The phlebotomist registration data also includes information identifying associated ones of the mobile health professional computing devices 14(1)-14(n) that can be used by the medical service management computing device 12 to track the geographic location of the associated phlebotomists. The phlebotomist registration data can be stored in the health professional database 44 and can also include bank account information used to process electronic payments to the phlebotomists for performing blood draws, as described and illustrated in more detail later. Optionally, the medical service management computing device 12 can automatically obtain background check results on each phlebotomist that can be reviewed by an administrator prior to registration.

In this example, the medical service management computing device 12 obtains physician registration data and laboratory registration data via web page interface(s) provided to the medical care provider computing devices 16(1)-16(n) and the laboratory computing devices 20(1), respectively. The physician data can include contact and login information and information regarding the associated medical practice, for example. The laboratory registration data can include laboratory representative contact and login information for laboratories that analyze drawn blood in this example.

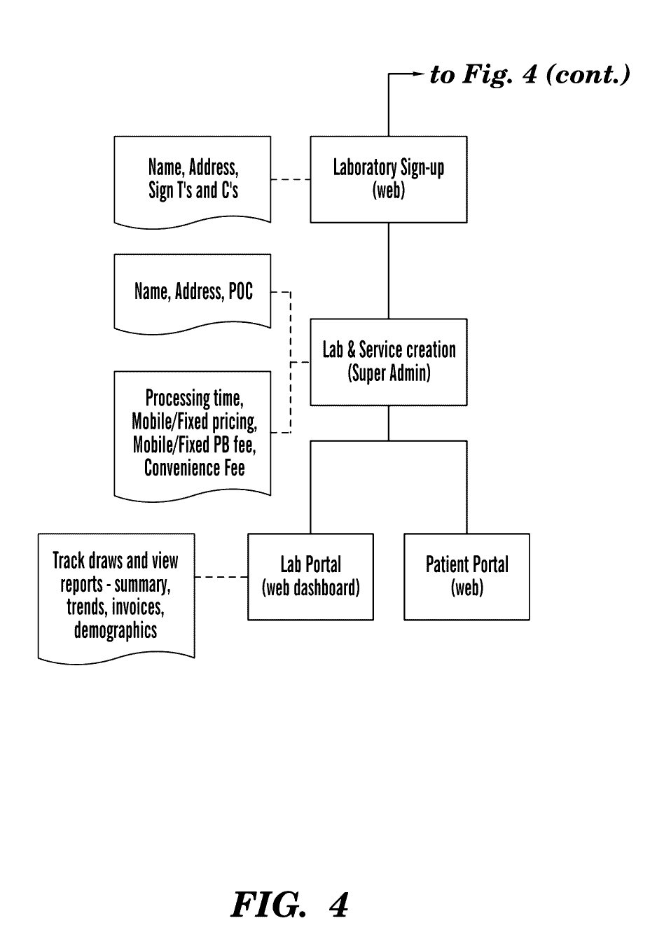

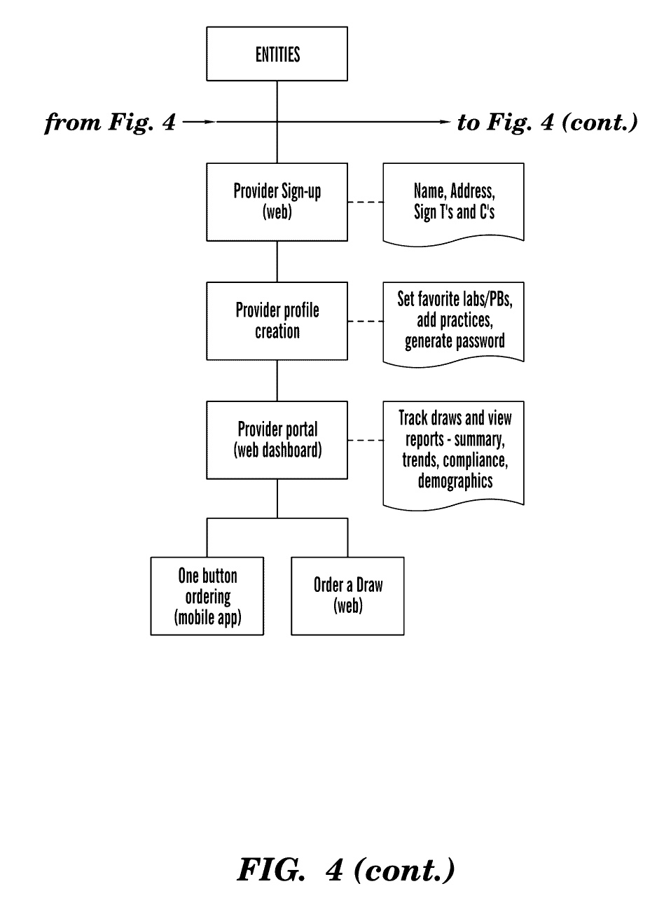

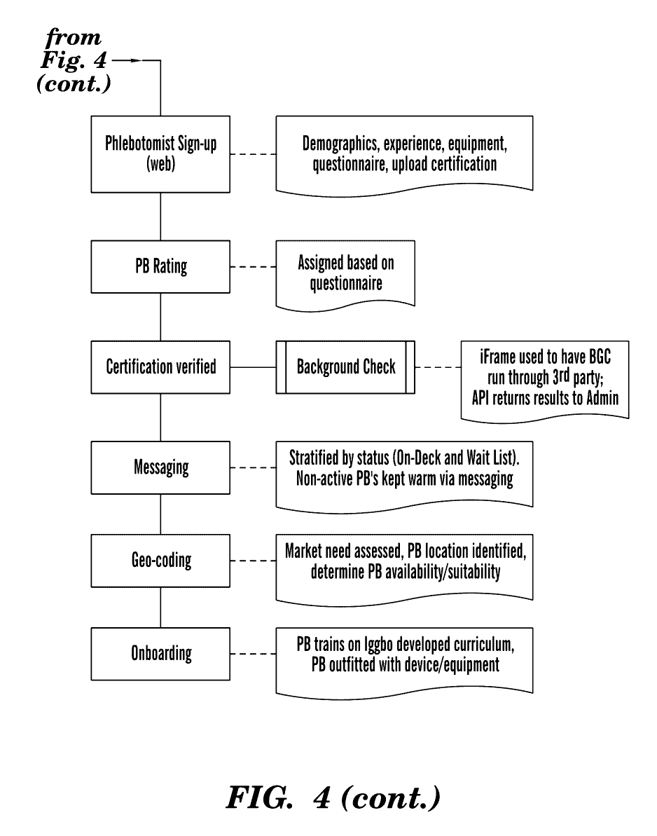

Referring to FIG. 4, a block diagram illustrating registration aspects of an exemplary method for facilitating medical services by mobile health professionals is illustrated. In this example, the medical service management computing device 12 facilitates registration of entities including laboratories, medical care providers, and phlebotomists. A user representing a laboratory can use one of the laboratory computing devices 20(1)-20(n) to submit contact information for the lab, point of contact information for the user, processing times, and pricing types and fees, among other information, to the medical service management computing device 12.

Once registered, the medical service management computing device 12 can send a lab portal dashboard web page to the one of the laboratory computing devices 20(1)-20(n). The lab portal dashboard web page can facilitate tracking of associated blood draws, as well as reports, summaries, trends, invoices, and demographics of associated patients, among other information.

A medical care provider using one of the medical care provider computing devices 16(1)-16(n) can submit contact information, set favorite laboratories and/or phlebotomists and submit practice information, for example, to the medical service management computing device 12, as illustrated in FIG. 4. Once registered, the medical service management computing device 12 can send a provider portal dashboard web page to the one of the medical care provider computing devices 16(1)-16(n). The provider portal dashboard web page can facilitate tracking of blood draws, as well as reports, summaries, trends, compliance of associated patients, and demographics of associated patient, among other information. Additionally, in this example, the provider portal dashboard web page can facilitate ordering of a blood draw for a patient, as described and illustrated in more detail later.

A phlebotomist using one of the mobile health professional computing devices 14(1)-14(n) can submit demographic, experience, equipment, and questionnaire information and upload proof of certification(s), for example, as illustrated in FIG. 4. In response, the medical service management computing device 12 can assign an initial rating to the phlebotomist based on experience level, certifications, and any other obtained information. The rating can change over time, as explained in more detail later. Optionally, the medical service management computing device 12 can perform an automated background check and/or verify the certification(s). Once registered, the medical service management computing device 12 can send phlebotomist portal dashboard web pages to one of the mobile health professional computing devices 14(1)-14(n) that facilitate receiving and accepting invitations to perform blood draws and managing an appointment schedule, among other functionality, as described and illustrated in more detail later.

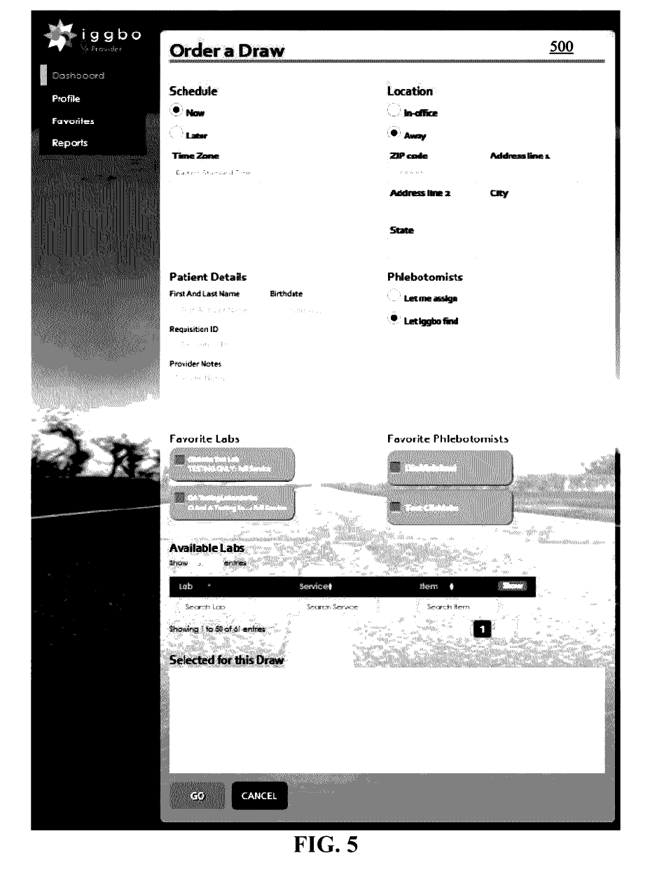

Referring back to FIG. 3, in step 302, the medical service management computing device 12 obtains an order for a blood draw from a physician or a patient. Referring to FIG. 5, an exemplary medical service order interface 500 for use by a physician is illustrated. In this example, the medical service management computing device 12 can send the medical service order interface 500 to one of the medical care provider computing devices 16(1)-16(n) in response to a received request from a registered physician. The medical service order interface 500 is configured to receive an indication of whether the blood draw for a patient is to occur as soon as possible or at a later date/time, an order location (e.g., an address) that the blood draw is to occur, various patient details, and optionally one or more favorite laboratories and/or phlebotomists.

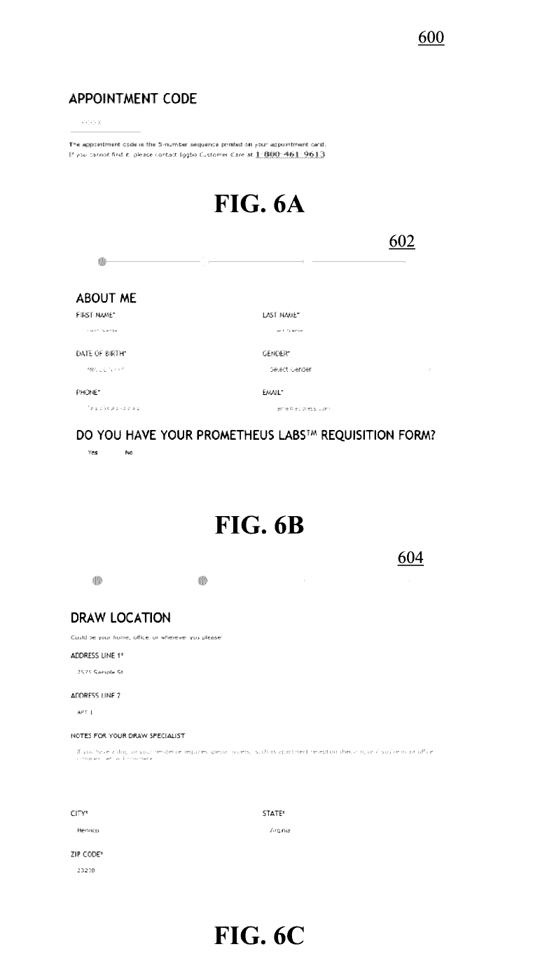

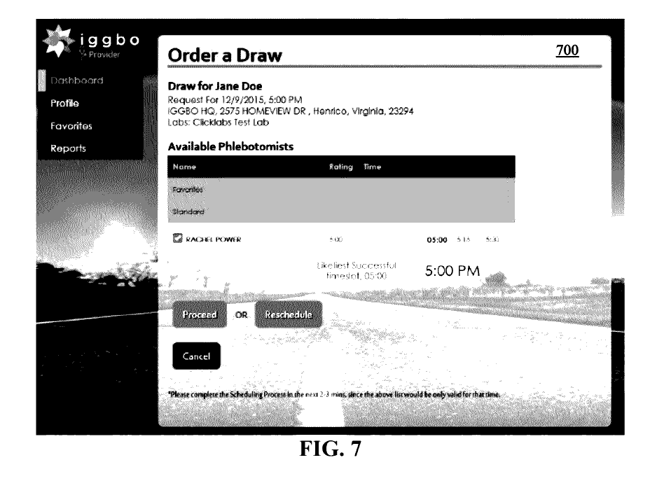

Referring to FIGS. 6A, 6B, and 6C, exemplary medical service order interfaces 600, 602, and 604, respectively, for use by a patient are illustrated. In this example, a patient can submit a code via the interface 600 and using one of the patient computing devices 18(1)-18(n). The code is preconfigured to be associated with the patient's physician and may be provided to the patient from the patient's physician. In response to the submission, the medical service management computing device 12 can confirm the code is valid and send the interfaces 602 and 604 to the one of the patient computing devices 18(1)-18(n). The interfaces 602 and 604 facilitate submission by the patient of demographic and blood draw location information and, optionally, a preferred blood draw time. Other methods for receiving a blood draw order in step 302 can also be used.

In step 304, the medical service management computing device 12 retrieves appointment schedule data optionally stored in the memory 24 for a phlebotomist. Accordingly, the medical management computing device 12 in this example stores appointment schedule data for all of the registered phlebotomists. The appointment schedule data includes at least an appointment location (e.g., address) and an appointment time of each appointment scheduled for each of the phlebotomists. Optionally, the appointment schedule data also includes information regarding the patient, physician, and/or laboratory associated with each appointment, as well as an indication of the services being performed and/or an estimated duration of each appointment.

In step 306, the medical service management computing device 12 determines whether the phlebotomist is available to perform the blood draw for the patient based on the obtained order received in step 302. Accordingly, the medical management computing device 12 analyzes the appointment schedule data in this example to determine whether the phlebotomist has a direct conflict based on the order time indicated in the blood draw order. If the medical service management computing device 12 determines that the phlebotomist is available to perform the blood draw for the patient, then the Yes branch is taken to step 308.

In step 308, the medical service management computing device 12, determines ingress and egress times based at least in part on the order location in the order and the appointment locations of appointments included in the appointment schedule data for the phlebotomist that are prior and subsequent to the order time in the order. Accordingly, the ingress time in this particular example represents the travel time for the phlebotomist to travel from the appointment location associated with the prior appointment to the order location in the blood draw order. The egress time represents the travel time for the phlebotomist to travel from the order location in the blood draw order, and at the expected end of that blood draw, to the appointment location associated with the subsequent appointment.

Optionally, the medical service management computing device 12 can use an API and third party service to determine the ingress and egress times. Also optionally, the medical service management computing device 12 can determine the traffic volume based on historical or current traffic volume information at the relevant times associated with the various appointments in order to more accurately determine the ingress and egress travel times. Other information can also be used to determine the ingress and egress travel times in other examples.

In step 310, the medical service management computing device 12 determines whether the phlebotomist is capable of performing the ordered blood draw based on the ingress and egress times. Accordingly, the medical service management computing device 12 can determine whether the ingress and egress times render the phlebotomist incapable of performing the ordered blood draw based on the expected durations of the prior appointment and the ordered blood draw. The expected durations can be determined based on the types of tests ordered, expected difficulty of the patient, phlebotomist rating or experience, or any other criteria.

Optionally, the medical service management computing device 12 further determines the capability of the phlebotomist to perform the ordered blood draw based on certifications and equipment information associated with the phlebotomist in the phlebotomist registration data. Accordingly, in this example, the medical service management computing device 12 further filters out the phlebotomist if the phlebotomist is not authorized or qualified to perform the ordered blood draw.

If the medical service management computing device 12 determines in step 310 that the phlebotomist is capable of performing the ordered blood draw, then the Yes branch is taken to step 312. In step 312, the medical service management computing device 12 stores an indication of the phlebotomist in the memory 24, for example. Subsequent to storing the indication in step 312, or if the medical service management computing device 12 determines in step 306 that the phlebotomist is not available, then the medical service management computing device proceeds to step 314.

In some examples, the medical service management computing device 12 can determine subsequent to step 310 whether the phlebotomist matches a favorite phlebotomist identified by the patient's physician, as identified in the physician registration data or in the blood draw order, for example. In these examples, the medical service management computing device 12 can proceed directly to step 316 without performing steps 312 or 314 when a match of a favorite phlebotomist is identified.

However, in step 314 in this example, the medical service management computing device 12 determines whether there are any more phlebotomists for which availability and capability should be analyzed. Optionally, the medical service management computing device 12 can be configured to generate an initial subset of possible phlebotomists based on general geographic location or other criteria prior to performing step 304.

While one available and capable phlebotomist may be identified, the medical service management computing device 12 can be configured, in some examples, to analyze additional phlebotomists in the subset of possible phlebotomists in order to select, or provide for selection, one or more phlebotomists that match an identified favorite phlebotomist, have a relatively high quality rating, or have a relatively high likelihood of carrying out the ordered blood draw (e.g., based on having the shortest ingress time or closest proximity). Accordingly, if the medical service management computing device 12 determines there are more phlebotomists to be analyzed, then the Yes branch is taken back to step 304 and appointment schedule data for another phlebotomist is retrieved.

However, if the medical service management computing device 12 determines in step 314 that there are no more phlebotomists that should be analyzed, then the No branch is taken to step 316. In step 316, the medical service management computing device 12 sends an indication to perform the blood draw to one or more phlebotomists via one or more of the mobile health professional computing devices 14(1)-14(n) based on the indications stored in the memory 24 in step 312.

Optionally, the invitation(s) can be sent to one or more of the phlebotomists previously identified by the patient's physician as a favorite phlebotomist, having the highest quality ratings, having a closest associated proximity, or having the highest likelihood of completing the blood draw. Other criteria can also be used to identify phlebotomists and the associated one or more of the mobile health professional computing device(s) 14(1)-14(n) to which an invitation should be sent.

In another example, the phlebotomists corresponding to the indications stored in the memory 24 in step 312 are provided to one of the medical care provider computing devices 16(1)-16(n) associated with the patient's physician, or one of the patient computing devices 18(1)-18(n) associated with the patient, for selection. Referring to FIG. 7, an exemplary mobile health professional selection interface 700 is illustrated. In this example, a physician or patient can use the interface 700 to select one or more available and capable phlebotomists for which invitations to perform the blood draw for the patient should be sent to associated ones of the mobile health professional computing devices 14(1)-14(n).

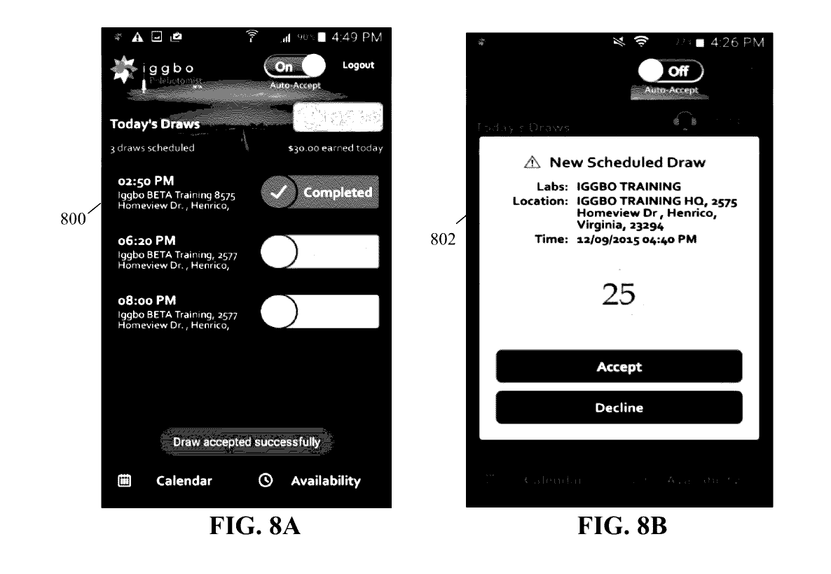

In step 318, the medical service management computing device 12 receives an acceptance of one or more of the invitations from one or more of the mobile health professional computing devices 14(1)-14(n). Referring to FIGS. 8A and 8B, exemplary mobile health professional interfaces 800 and 802, respectively, for viewing appointment information and receiving new invitations are illustrated. Referring more specifically to FIG. 8B, the interface 802 is used in this example to display on one of the mobile health professional computing devices 14(1)-14(n) the invitation to perform the blood draw, including the laboratory to which the drawn blood should be sent, the location of the ordered blood draw, and the order time of the ordered blood draw.

Optionally, the medical service management computing device 12 can be configured to schedule the blood draw for the phlebotomist from whom an acceptance of the invitation was first received from an associated one of the mobile health professional computing devices 14(1)-14(n). In another example, the medical service management computing device 12 can establish a time period and can schedule the blood draw for the highest rated phlebotomist, or for the phlebotomist most likely to be able to carry out the blood draw for the patient (e.g., based on proximity or shortest ingress or egress time), for which an acceptance of the invitation was received during the time period from an associated one of the mobile health professional computing devices 14(1)-14(n). Other criteria can be used to determine the phlebotomist for which the blood draw should be scheduled when multiple acceptances are received by the medical service management computing device 12.

Referring back to FIG. 3, in step 320, the medical service management computing device 12 updates the appointment schedule data stored in the memory 24 for the phlebotomist for which the blood draw is to be scheduled to reflect the order. Referring back to FIG. 8A, the interface 800 is used to display scheduled blood draws on one of the mobile health professional computing devices 14(1)-14(n). The information for the scheduled blood draws can be provided to the one of the mobile health professional computing devices 14(1)-14(n) from the appointment schedule data stored in the memory 24, for example. Accordingly, each phlebotomist can interface with a mobile application executed on one of the mobile health professional computing devices 14(1)-14(n) to manage invitations and scheduled appointments, as well as to perform other functionality to complete a blood draw, as described and illustrated in more detail later.

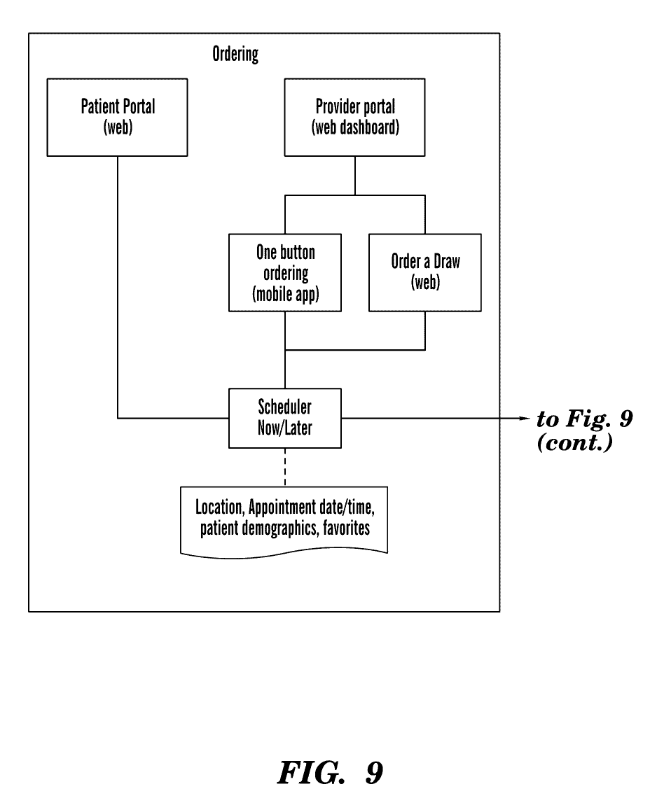

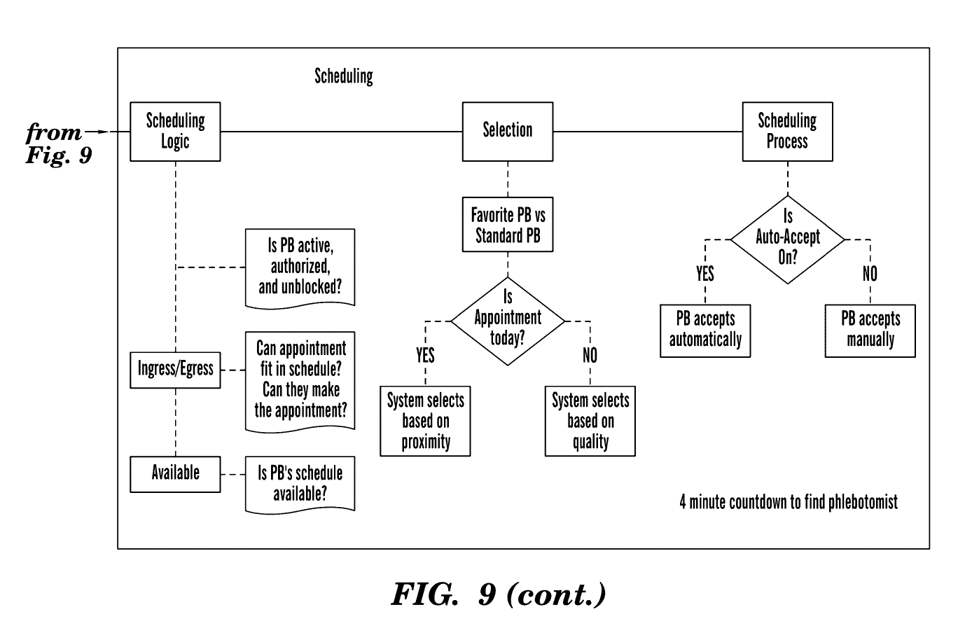

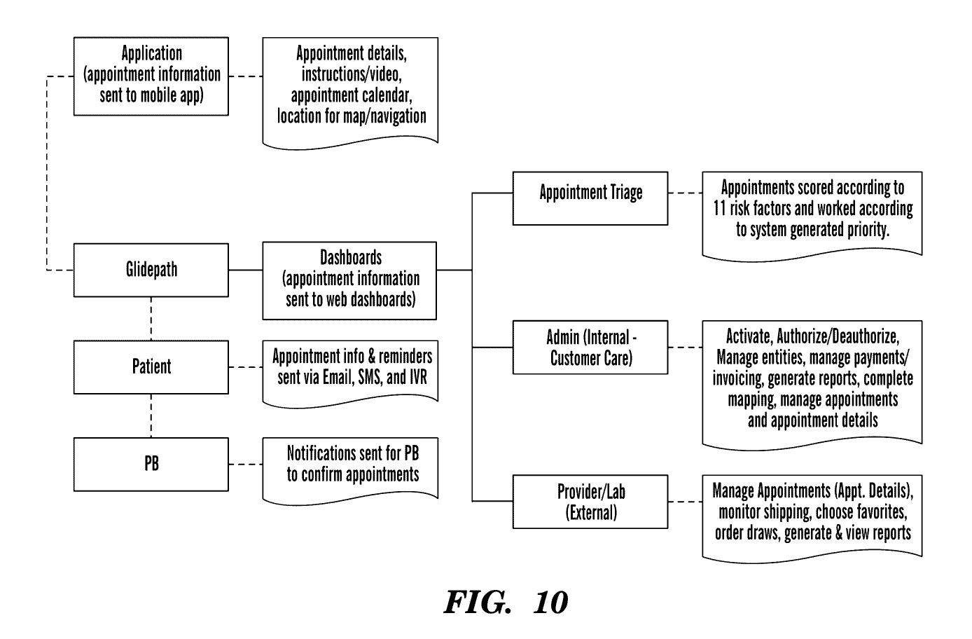

Referring to FIG. 9, a block diagram illustrating medical service ordering and scheduling aspects of an exemplary method for facilitating medical services by mobile health professionals is illustrated. In this particular example, blood draws can be ordered via a patient portal or a medical care provider portal on one of the patient computing devices 18(1)-18(n) or one of the medical care provider computing devices 16(1)-16(n), respectively. The various portals can be provided via mobile applications or web pages sent via the communication network(s) 22 by the order management module 34, for example. Irrespective of the portal that is used to schedule the blood draw, the patient or medical care provider has the option of scheduling the blood draw now or at a later time in this example. Accordingly, the patient or medical care provider submits location, appointment date/time, patient demographics, and favorites, among other information as described and illustrated earlier, in order to initiate ordering of the blood draw.

Once the blood draw order is submitted to the medical service management computing device 12, the medical service management computing device 12 initiates the scheduling module 36 to identify phlebotomists that are active and authorized for which associated appointment schedule data should be analyzed to determine availability and capability to complete the ordered blood draw. For the initial set of the phlebotomists, the medical service management computing device 12 then generates ingress and egress times to determine whether the ordered blood draw can fit in the schedule of each phlebotomist and, in other words, whether the phlebotomists can make the blood draw appointment and also successfully complete any appointments that are prior and subsequent to the ordered blood draw.

In this particular example, the medical service management computing device 12 then selects from the filtered set of phlebotomists based on whether any of the phlebotomists match a favorite phlebotomist or whether a standard phlebotomist should be invited to perform the blood draw. In this example, the medical service management computing device 12 selects the phlebotomist to perform the blood draw on behalf of the ordering physician or patient. Accordingly, the medical service management computing device 12 selects the phlebotomist from the filtered set based on proximity to the order location in the blood draw order if the blood draw order indicates that the blood draw should be scheduled as soon as possible.

In these examples, the medical service management computing devices 12 can determine the location of the phlebotomists, for purposes of generating the ingress time, from the appointment schedule data or based on communication with the mobile health professional computing devices 14(1)-14(n), which are configured to provide a GPS location upon request. Alternatively, the medical service management computing device 22 selects the phlebotomist from the filtered set based on quality, which can be determined based on the quality score or rating associated with each phlebotomist generated as described and illustrated earlier and updated over time as described and illustrated in more detail later. Other methods for selecting the phlebotomist for which an invitation to perform the blood draw should be sent to the associated one of the mobile health professional computing devices 14(1)-14(n) can also be used.

Once the phlebotomist(s) are identified, the medical service management computing device 12 sends an invitation to each of the mobile health professional computing devices 14(1)-14(n) associated with the phlebotomist(s). Optionally, the invitations can be sent via mobile application executing on the mobile health professional computing devices 14(1)-14(n). Also optionally, the mobile application can be configured to automatically accept invitations that are received. Alternatively, the invitations can be presented for manual acceptance by the phlebotomist.

Referring back to FIG. 3, in step 322, the medical service management computing device 12 determines whether the appointment associated with the ordered blood draw requires reassignment. Accordingly, in this example, subsequent to updating the appointment schedule data, the compliance module 38 executing on the medical service management computing device 12 schedules a number of automated reminders sent to the patient and/or the selected phlebotomist at various times. In some examples, the patient is reminded of the appointment via e-mail, SMS message, and/or interactive voice response reminders sent to one of the patient computing devices 18(1)-18(n) associated with the patient.

The phlebotomist is reminded of the appointment in this example via notification requiring confirmation to one of the mobile health professional computing device 14(1)-14(n) associated with the selected phlebotomist. Other types and number of reminders can also be used by the medical service management computing device 12 in order to improve compliance. Optionally, if the phlebotomist fails to confirm the appointment, or other submit a required response to a notification, then the medical service management computing device 12 can determine that the appointment requires reassignment. Also optionally, the phlebotomist can use the mobile application executing on the one of the medical service provide computing devices 14(1)-14(n) to cancel the appointment. Such a cancellation, when received by the medical service management computing device 12 would also result in a determination that the appointment required reassignment.

Additionally, in this particular example, the monitoring module 40 executing on the medical service management computing device 12 is configured to periodically determine a current location of the one of the mobile health professional computing devices 14(1)-14(n), such as by interfacing with GPS functionality of the mobile health professional computing devices 14(1)-14(n), for example. The medical service management computing device 12 then generates an ingress time based on the current location of the one of the mobile health professional computing devices 14(1)-14(n) and the order location. The medical service management computing device 12 then determines whether the ingress time is greater than a difference between the order time and a current time, which would indicate that the phlebotomist does not have enough time to make the appointment.

Accordingly, if the medical service management computing device 12 determines in real-time that the ingress time is greater than a difference between the order time and the current time, the medical service management computing device 12 can determine that the appointment requires reassignment. Other methods of determining whether the appointment requires reassignment can also be used. Accordingly, if the medical service management computing device 12 determines in step 322 that the appointment requires reassignment, then the Yes branch is taken back to step 304. In some examples, a dashboard is output for an administrator to perform the selection of another phlebotomist to which the appointment should be reassigned, although other methods of selecting a new phlebotomist to perform the ordered blood draw can also be used.

Referring to FIG. 10, a block diagram illustrating compliance and monitoring aspects of an exemplary method for facilitating medical services by mobile health professionals is illustrated. In this particular example, the medical service management computing device 12 sends appointment details, instructions/videos, an appointment calendar synchronized with the appointment schedule data stored in the memory 24, and/or locations of appointments for map/navigational purposes, to a mobile application on the one of the mobile health professional computing devices 14(1)-14(n).

Concurrently, the medical service management computing device 12 initiates a reminder process designed to improve compliance. The reminder process periodically and automatically generates e-mail, SMS, and/or IVR messages to the patient via an associated one of the patient computing device 18(1)-18(n), as well as notifications to the phlebotomist via an associated one of the mobile health professional computing devices 14(1)-14(n).

Additionally, the medical service management computing device 12 is configured in this example to generate a plurality of web dashboards including appointment triage, administrative, and physician/laboratory web dashboards, although other web dashboards can be generated in other examples. The appointment triage web dashboard is configured to allow administrators to identify appointments for which manual intervention may be required to improve compliance (e.g., by reassigning an appointment to another phlebotomist). Optionally, the pending appointments managed by the medical service management computing device 12 can be scored according to a plurality of risk factors and prioritized for triage based on the scoring.

The risk factors can include the score or rating of the associated phlebotomist or the likelihood that the phlebotomist is not going to be able to make the appointment (e.g., due to volatile traffic volumes, a current heightened traffic volume, or a current ingress time of a phlebotomist for an appointment exceeding the amount of time until the appointment is scheduled to commence), although other factors can also be used to generate the risk level of the appointments. Accordingly, the appointment triage web dashboard can allow an administrator to view appointments according to priority determined based on risk level and intervene to initiate reassignment to another phlebotomist or take another action, for example. In other examples, the appointment triage web dashboard an allow administrators to perform other functionality.

The administrative web dashboard in this example is configured to allow administrators to activate and/or authorize/deauthorize phlebotomists manage physicians, phlebotomists, and laboratories, manage payments and invoicing (as described and illustrated in more detail later), generate reports, complete mapping, and manage various appointment details, although the administrative web dashboard can facilitate other functionality in other examples. Additionally, the physician/laboratory web dashboard in this example is provided by the medical service management computing device 12 to one of the medical care provider computing devices 16(1)-16(n) or one of the laboratory computing deices 18(1)-18(n), and allows a physician or a laboratory representative to manage associated appointments, monitor shipping of blood samples, set favorites, order blood draws, and generate and view reports, for example, although other functionality can also be provided by the provider/laboratory web dashboard in other examples.

Referring back to FIG. 3, if the medical service management computing device 12 determines in step 322 that the appointment does not require reassignment, then the No branch is taken to step 324. In step 324, the medical service management computing device 12 determines whether the ordered blood draw has commenced. The medical service management computing device 12 can determine a blood draw has commenced based on the phlebotomist using a mobile application on the one of the mobile health professional computing devices 14(1)-14(n) to indicate to the medical service management computing device 12 that the blood draw has started.

Accordingly, if the medical service management computing device 12 does not receive such a communication and determines that the blood draw has not commenced, then the No branch is taken back to step 322 and the medical service management computing device 12 essentially monitors the appointment for reassignment until the appointment commences. In examples in which the blood draw does not commence at the scheduled time, the medical service management computing device 12 can alert an administrator via the appointment triage web dashboard, for example, so that an action to reschedule the appointment can be taken.

However, if the medical service management computing device 12 determines that the blood draw has commenced, then the Yes branch is taken to step 326. In step 326, the medical service management computing device 12, the medical service management computing device 12 updates the quality score or rating for the phlebotomist.

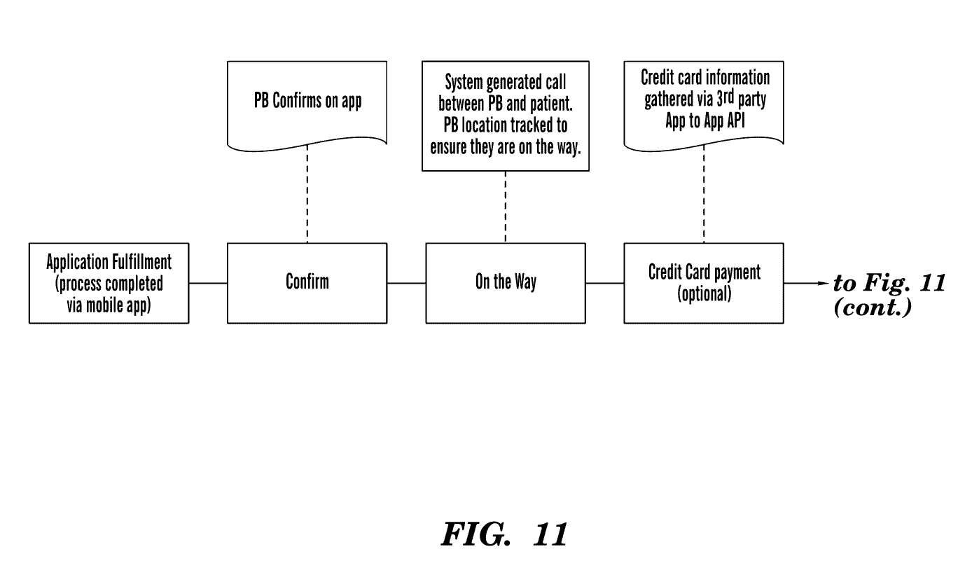

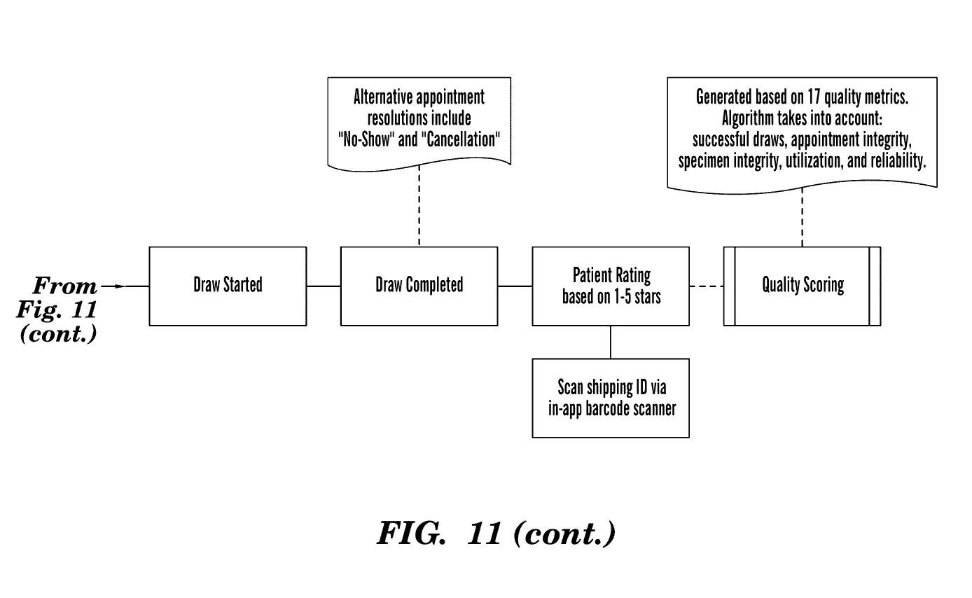

Referring to FIG. 11, a block diagram illustrating medical service processing aspects of an exemplary method for facilitating medical services by mobile health professionals is illustrated. In this particular example, the phlebotomist confirms the appointment with the medical service management computing device 12 and is tracked by geographic location by the medical service management computing device 12, as described and illustrated earlier. Optionally, upon arriving at the order location, the phlebotomist can use the mobile application executing on the one of the mobile health professional computing devices 14(1)-14(n) to facilitate receipt of a credit card payment for the blood draw by the patient. Next, the phlebotomist uses the mobile application executing on the one of the mobile health professional computing devices 14(1)-14(n) to indicate to the medical service management computing device 12 that the blood draw has commenced.

Subsequent to performing the blood draw, the phlebotomist uses the mobile application executing on the one of the mobile health professional computing devices 14(1)-14(n) to indicate to the medical service management computing device 12 that the blood draw has completed. Optionally, as part of the completion process, the phlebotomist obtains a patient rating from the patient via interaction with the mobile application executing on the one of the mobile health professional computing devices 14(1)-14(n), and the rating is communicated to the medical service management computing device 12.

Subsequent to determining that the blood draw has completed, the medical service management computing device 12 updates the quality score for the phlebotomist, optionally using the patient rating. In this particular example, the quality score for the phlebotomist is generated and/or updated based on a plurality of factors including the number of successful blood draws for the phlebotomist, appointment integrity, specimen integrity, utilization, and/or reliability, although other factors can also be used in other examples. The quality score can be used in automatic selection of phlebotomists, as described and illustrated earlier, as well as to identify phlebotomists that should be deauthorized, for example, although the quality score can also be used for other purposes in other examples.

Additionally, in this example, subsequent to obtaining the patient rating, the phlebotomist scans a shipping identifier via a barcode scanner included in the mobile application executing on the one of the mobile health professional computing devices 14(1)-14(n). The scanned identifier is sent to the medical service management computing device 12, which correlates the identifier with the patient to facilitate matching of the blood specimen with the patient by a laboratory and other entities utilizing the medical service management computing device 12, for example. Accordingly, the phlebotomist then ships the package having the identifier and including the specimen to a selected or default laboratory indicated in the blood draw order.

Referring back to FIG. 3, in step 328, the payment module 42 executing on the medical service management computing device 12 generates and sends an invoice to the laboratory associated with the blood draw. Subsequently, the medical service management computing device 12 receives a payment for the invoice and distributes a portion of the payment to the phlebotomist based on account data in the health professional database. Accordingly, this technology allows independent phlebotomists to receive payment for performing blood draws, as well as increases the channels by which clinical laboratories can receive blood specimens for analysis

Additionally, this technology advantageously improves compliance by patients and associated patient outcomes. In particular, this technology allows medical services to be provided at remote locations convenient to patients, improving the likelihood that the patient will comply with a physician's recommendation that the medical service be performed. Additionally, this technology improves compliance by filtering mobile health professionals based on the likelihood that the mobile health professional will be able to perform the medical service and by monitoring mobile health professionals until the medical service commences.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating medical services by mobile health professionals, comprising:
obtaining, by a medical service management computing device, an order for a medical service and appointment schedule data for a plurality of mobile health professionals comprising at least an appointment location and an appointment time of each of a plurality of appointments scheduled prior and subsequent to an order time in the order;
determining, by the medical service management computing device, ingress and egress travel times for each of the mobile health professionals based at least in part on an order location in the order and the appointment locations of the prior and subsequent appointments;
identifying, by the medical service management computing device, one or more of the mobile health professionals from a health professional database that are capable of providing the medical service at the order location and the order time based at least in part on the ingress and egress travel times and the appointment times of the prior and subsequent appointments;
sending, by the medical service management computing device, an invitation to one or more mobile health professional computing devices associated with one or more of the identified mobile health professionals;
receiving, by the medical service management computing device, an acceptance of the invitation from one of the mobile health professional computing devices; and
updating, by the medical service management computing device, the appointment schedule data for one of the identified mobile health professionals associated with the one of the mobile health professional computing devices for the order.

2. The method as claimed in claim 1, wherein data in the order identifies the medical service as a blood draw and the method further comprises receiving, by the medical service management computing device, a confirmation from the one of the mobile health professional computing devices that the medical service for the patient has been completed.

3. The method as claimed in claim 2, further comprising:
generating, by the medical service management computing device, an invoice for the blood draw and sending the invoice to a laboratory to which the drawn blood was sent for analysis in response to receiving the confirmation;
receiving, by the medical service management computing device, an electronic payment of the invoice from the laboratory; and
executing, by the medical service management computing device, an electronic payment transaction of at least a portion of the payment based on account data in the health professional database associated with the one of the identified mobile health professionals.

4. The method as claimed in claim 1, wherein the identifying the one or more mobile health professionals is further based on obtained authorization data indicating an authorization of the one or more mobile health professionals to perform the medical service, physician preference data, or customer rating data.

5. The method as claimed in claim 1, further comprising obtaining, by the medical service management computing device, traffic volume data, wherein the determining the ingress travel time and the egress travel time further comprises determining at least one of the ingress travel time or the egress travel time further based on the traffic volume data.

6. The method as claimed in claim 1, further comprising:
periodically determining, by the medical service management computing device and subsequent to receiving the acceptance of the invitation, a current location of the one of the mobile health professional computing devices;
wherein the determining the ingress travel time and the egress travel time further comprises determining an updated ingress travel time based on the current location of the one of the mobile health professional computing devices and the order location;
determining, by the medical service management computing device, when the updated ingress time is greater than a difference between the order time and a current time; and
automatically reassigning, by the medical service management computing device, the medical service to another one of the identified mobile health professionals, when the determining indicates that the updated ingress time is greater than the difference between the order time and the current time.

7. A medical service management computing device comprising at least one processor and a memory coupled to the processor which is configured to be capable of executing programmed instructions comprising and stored in the memory to:
obtain an order for a medical service and appointment schedule data for a plurality of mobile health professionals comprising at least an appointment location and an appointment time of each of a plurality of appointments scheduled prior and subsequent to an order time in the order;
determine ingress and egress travel times for each of the mobile health professionals based at least in part on an order location in the order and the appointment locations of the prior and subsequent appointments;
identify one or more of the mobile health professionals from a health professional database that are capable of providing the medical service at the order location and the order time based at least in part on the ingress and egress travel times and the appointment times of the prior and subsequent appointments;
send an invitation to one or more mobile health professional computing devices associated with one or more of the identified mobile health professionals;
receive an acceptance of the invitation from one of the mobile health professional computing devices; and
update the appointment schedule data for one of the identified mobile health professionals associated with the one of the mobile health professional computing devices for the order.

8. The medical service management computing device as claimed in claim 7, wherein data in the order identifies the medical service as a blood draw and the processor coupled to the memory is further configured to be capable of executing at least one additional programmed instruction comprising and stored in the memory to receive a confirmation from the one of the mobile health professional computing devices that the medical service for the patient has been completed.

9. The medical service management computing device as claimed in claim 7, wherein the processor coupled to the memory is further configured to be capable of executing at least one additional programmed instruction comprising and stored in the memory to:
generate an invoice for the blood draw and sending the invoice to a laboratory to which the drawn blood was sent for analysis in response to receiving the confirmation;
receive an electronic payment of the invoice from the laboratory; and
execute an electronic payment transaction of at least a portion of the payment based on account data in the health professional database associated with the one of the identified mobile health professionals.

10. The medical service management computing device as claimed in claim 7, wherein the identifying the one or more mobile health professionals is further based on obtained authorization data indicating an authorization of the one or more mobile health professionals to perform the medical service, physician preference data, or customer rating data.

11. The medical service management computing device as claimed in claim 7, wherein the processor coupled to the memory is further configured to be capable of executing at least one additional programmed instruction comprising and stored in the memory to obtain traffic volume data, wherein the determining the ingress travel time and the egress travel time further comprises determining at least one of the ingress travel time or the egress travel time further based on the traffic volume data.

12. The medical service management computing device as claimed in claim 7, wherein the processor coupled to the memory is further configured to be capable of executing at least one additional programmed instruction comprising and stored in the memory to:
periodically determine, subsequent to receiving the acceptance of the invitation, a current location of the one of the mobile health professional computing devices;
generate an updated ingress time based on the current location of the one of the mobile health professional computing devices and the order location;
determine when the updated ingress time is greater than a difference between the order time and a current time; and
automatically reassign the medical service to another one of the identified mobile health professionals, when the determining indicates that the updated ingress time is greater than the difference between the order time and the current time.

13. A non-transitory computer readable medium having stored thereon instructions for facilitating medical services by mobile health professionals comprising executable code which when executed by at least one processor, causes the processor to perform steps comprising:
obtaining an order for a medical service and appointment schedule data for a plurality of mobile health professionals comprising at least an appointment location and an appointment time of each of a plurality of appointments scheduled prior and subsequent to an order time in the order;
determining ingress and egress travel times for each of the mobile health professionals based at least in part on an order location in the order and the appointment locations of the prior and subsequent appointments;
identifying one or more of the mobile health professionals from a health professional database that are capable of providing the medical service at the order location and the order time based at least in part on the ingress and egress travel times and the appointment times of the prior and subsequent appointments;
sending an invitation to one or more mobile health professional computing devices associated with one or more of the identified mobile health professionals;
receiving an acceptance of the invitation from one of the mobile health professional computing devices; and
updating the appointment schedule data for one of the identified mobile health professionals associated with the one of the mobile health professional computing devices for the order.

14. The non-transitory computer readable medium of claim 13, wherein data in the order identifies the medical service as a blood draw, the non-transitory computer readable medium further having stored thereon instructions comprising executable code which when executed by the processor further causes the processor to perform one or more additional steps comprising receiving a confirmation from the one of the mobile health professional computing devices that the medical service for the patient has been completed.

15. The non-transitory computer readable medium of claim 13, further having stored thereon instructions comprising executable code which when executed by the processor further causes the processor to perform one or more additional steps comprising:
generating an invoice for the blood draw and sending the invoice to a laboratory to which the drawn blood was sent for analysis in response to receiving the confirmation;
receiving an electronic payment of the invoice from the laboratory; and
executing an electronic payment transaction of at least a portion of the payment based on account data in the health professional database associated with the one of the identified mobile health professionals.

16. The non-transitory computer readable medium of claim 13, wherein the identifying the one or more mobile health professionals is further based on obtained authorization data indicating an authorization of the one or more mobile health professionals to perform the medical service, physician preference data, or customer rating data.

17. The non-transitory computer readable medium of claim 13, further having stored thereon instructions comprising executable code which when executed by the processor further causes the processor to perform one or more additional steps comprising obtaining traffic volume data, wherein the determining the ingress travel time and the egress travel time further comprises determining at least one of the ingress travel time or the egress travel time further based on the traffic volume data.

18. The non-transitory computer readable medium of claim 13, further having stored thereon instructions comprising executable code which when executed by the processor further causes the processor to perform one or more additional steps comprising:
periodically determining, subsequent to receiving the acceptance of the invitation, a current location of the one of the mobile health professional computing devices;
generating an updated ingress time based on the current location of the one of the mobile health professional computing devices and the order location;
determining when the updated ingress time is greater than a difference between the order time and a current time; and
automatically reassigning the medical service to another one of the identified mobile health professionals, when the determining indicates that the updated ingress time is greater than the difference between the order time and the current time.
